(19) United States
(12) Patent Application Publication
(10) Pub. No.: US 2012/0188921 A1
(43) Pub. Date: Jul. 26, 2012

(54) PERFORMING WIRELSS COMMUNICATIONS IN HALF-DUPLEX AND FULL-DUPLEX MODES

(76) Inventor: Shinji HAMAI, Osaka (JP)

(21) Appl. No.: 13/437,379

(22) Filed: Apr. 2, 2012

Related U.S. Application Data
(63) Continuation of application No. PCT/JP2011/004672, filed on Aug. 23, 2011.

(30) Foreign Application Priority Data
Aug. 25, 2010 (JP) 2010-187811

(51) Int. Cl. H04L 5/16

(52) U.S. Cl. 370/296

(57) ABSTRACT

In a wireless communication system including at least a plurality of wireless communication terminal apparatuses each including first and second wireless communication apparatuses, the first wireless communication apparatus includes first and second wireless communication parts. The first wireless communication part transceives digital data in a half-duplex communication mode via a first wireless communication path, and the second wireless communication part transceives digital data in a full-duplex communication mode via a second wireless communication path. A first control part controls transmission of digital data for the first and second wireless communication parts. The second wireless communication apparatus includes third and fourth wireless communication parts. The first control part controls the first and second wireless communication parts to transmit identical digital data from both of the first and second wireless communication parts when instructing the second wireless communication apparatus to transmit digital data.

This is a continuation application based on PCT application No. PCT/JP2011/004672 as filed on Aug. 23, 2011, which claims priority to Japanese patent application No. JP 2010-187811 as filed Aug. 25, 2010, the contents of which are incorporated herein by reference.

### TECHNICAL FIELD

The present application relates to a wireless communication system that includes at least a plurality of wireless communication terminal apparatuses and performs wireless communications in half-duplex and full-duplex modes via a wireless communication path and to wireless communication apparatuses for use in the wireless communication system.

### BACKGROUND

In recent years, a technology to enable image data to be transmitted by using a wireless signal like Wireless HD Standard has been developed. By using the technology of Wireless HD Standard, no wiring is necessary between a television receiver having a screen and an apparatus such as a player for reproduction of discs, making it possible to make the layout free.

Moreover, a personal area network (hereinafter referred to as PAN) to perform wireless communications with an apparatus located at a short distance has also been developed. PAN is a wireless communication technology within a range of several meters for headphones, cardiotachometry, remote controllers, equipment control and the like, and it begins to be used as remote controllers of television receivers and recorders. The system compliant to the Wireless HD Standard, which is able to perform high-speed communications, conversely consumes much power. Therefore, it is expedient to use the remote controllers for controlling television receivers and players or the technology of the IEEE802.15.4 standard that is one of PAN and the conventional infrared-ray remote controllers for use in communications between the television receiver and the player in power-off states.

The IEEE802.15.4 standard adopts half-duplex communications such that transmission and reception are not simultaneously performed. The reliability is improved by performing confirmation of packet arrival by an acknowledge signal and performing retry when no packet reaches.

FIG. 7 is a block diagram showing a configuration of a wireless video reproduction system 700. The wireless video reproduction system 700 is configured to include a player 40 and a television receiver 41, the player 40 is configured to include a remote controller 42, and the television receiver 41 is configured to include a remote controller 43. It is noted that Wireless HD transceiver parts 50 and 51 perform wireless communications by full-duplex communication in a system compliant to the Wireless HD Standard.

When reproduction of a Blu-ray Disc (hereinafter, referred to as a BD or BD disc) in FIG. 7, the reproduction of the BD disc is performed by a BD drive 10, and the reproduced stream is outputted to a decoder 11. The decoder 11 converts the inputted stream into a video signal and outputs the converted signal to the Wireless HD transceiver part 50. The Wireless HD transceiver part 50 encodes the inputted video signal into a wireless signal that includes the video signal and transmits the wireless signal to the Wireless HD transceiver part 51 of the television receiver 41. On the other hand, the Wireless HD transceiver part 51 receives the wireless signal, decodes the video signal from the received wireless signal, outputs the resulting signal to a display panel 21. The display panel 21 displays the image of the video signal.

In the player 40, the BD drive 10, the decoder 11 and the Wireless HD transceiver parts 50 are supplied with the power by a power supply circuit 13, and the power supply is arbitrarily turned on or off by a control part 52. Moreover, the Wireless HD transceiver part 51 and the display panel 21 are supplied with the power by a power supply circuit 23, and the power supply is arbitrarily turned on or off by a control part 53. The parts other than the parts supplied with the power by the power supply circuit 13 and the power supply circuit 23 are consistently supplied with the power by a power supply circuit not shown in the figure.

The remote controller 42 is configured to include a keyboard 54 and a wireless transmitter part 30. The keyboard 54 includes a plurality of keys for operating the player 40 and the television receiver 41, and a command is assigned to each of the keys. When a certain key of the keyboard 54 is selected, a command corresponding to the selected key is transmitted to the wireless transmitter part 30, and the wireless transmitter part 30 transmits the received command to a wireless transceiver part 17. These commands include, for example, a turning ON/OFF command for turning ON/OFF the player 40, a turning ON/OFF command for turning ON/OFF the television receiver 41, a reproduction, stop and fast-forwarding command for reproduction, stop and fast-forwarding of a BD inserted in the BD drive 10, and so on.

Moreover, the remote controller 43 is configured to include a keyboard 55 and a wireless transmitter part 32. The keyboard 55 includes a plurality of keys for operating the player 40 and the television receiver 41, and a command is assigned to each of the keys. When a certain key of the keyboard 55 is selected, a command corresponding to the selected key is transmitted to the wireless transmitter part 32, and the wireless transmitter part 32 transmits the received command to a wireless transceiver part 24. The commands include, for example, a turning ON/OFF command for turning ON/OFF the player 40, a turning ON/OFF command for turning ON/OFF the television receiver 41, a reproduction, stop and fast-forwarding command for reproduction, stop and fast-forwarding of a BD inserted in the BD drive 10, a change in the brightness command for changing the brightness of the screen, and so on.

In this case, the wireless transmitter parts 30 and 32, the wireless transceiver part 17 and the wireless transceiver part 24 perform wireless communications in the half-duplex communication mode in a system compliant to the IEEE802.15.4 standard.

The wireless transceiver part 17 receives a command transmitted from the remote controller 42 and the wireless transceiver part 24, and outputs the command to the control part 52. Moreover, upon receiving a command transmission instruction from the control part 52, the wireless transceiver part 17 transmits the command to the wireless transceiver part 24. Upon receiving the command, the wireless transceiver part 17 replies with an acknowledgement signal to the originating part. When the acknowledgement signal is received within a specified time from the time the command is transmitted, the originating part executes retransmission of the command. The originating part may retransmit the command until the acknowledgement signal can be received, a specified time out has been reached, or a specified number of retransmission attempts has been made.

A power switch 15 is a switch operable by the user, and when the power switch 15 is selected, information regarding power is outputted to the control part 52. A timer circuit 16 internally includes a clock circuit for monitoring whether a specified time has been reached. If so, the timer circuit 16 notifies the control part 52 of the same. The power supply circuit 13 supplies the power to the BD drive 10, the decoder 11 and the Wireless HD transceiver part 50. The power supply circuit 13 supplies the power when the power supply circuit 13 receives instructions to start up from the control part 52. Similarly, the power supply circuit 13 stops supplying the power when the power supply circuit 13 receives instructions to stop supplying power.

FIG. 8 is a flow chart showing a communication control process 800 executed by the control part 52 of the player 40 in the wireless video reproduction system 700 of FIG. 7. The process 800 begins with the control part 52 judging whether there is a notification from the timer circuit 16 (in step 120). When there is such notification (step 120, YES), the control part 52 judges the power state (in step 123). If the power state is OFF (step 123, OFF), the control part 52 instructs the power supply circuit 13 to start supplying power to the BD driver 10, decoder 11, and Wireless HD transceiver part 50 (in step 124). After the power supply circuit 13 begins supplying power to the BD driver 10, decoder 11, and Wireless HD transceiver part 50, the control part 52 outputs a power-on command to the wireless transceiver part 17, and a reproduction command to the BD drive 10 to reproduce the BD (in step 125). In a case where the power state is ON (step 123, ON), the control part 52 outputs a power-on command to the wireless transceiver part 17, and a reproduction command to the BD drive 10 to reproduce the BD (in step 125).

When there is no notification from the timer circuit 16 (step 120, NO), the control part 52 judges whether there is a notification from the power switch 15 (in step 121). When there is such notification from the power switch 15 (step 121, YES), the control part 52 determines the power state (in step 126). When the power state is ON (step 125, ON), the control part 52 instructs the wireless transceiver part 17 to transmit a power-off command, and instructs the power supply circuit 13 to stop supplying power to the BD driver 10, decoder 11, and Wireless HD transceiver part 50 (in step 127). When the power state is OFF (step 125, OFF), the control part 52 instructs the power supply circuit 13 to start supplying power to the BD driver 10, decoder 11, and Wireless HD transceiver part 50. Additionally, the control part 52 outputs a power-on command to the wireless transceiver part 17 (in step 126).

When there is no notification from the power switch 15 (NO in step 121), the presence or absence of the command notification from the wireless transceiver part 17 is judged (in step 122). When the command notification is present (step 122, YES), the control part 52 determines the power state (in step 129). In a case where the power state is OFF (step 129, OFF), the power supply circuit 13 is instructed to start supplying power to the BD driver 10, decoder 11, and Wireless HD transceiver part 50 (in step 130). In a case where the power state is ON (step 129, ON) or after the power supply circuit 13 is started up (in step 130), the control part 52 judges whether the command is a command for the player 40 (in step 131). The keyboard 54 of the remote controller 42 has keys for controlling operation of the player 40 and keys for controlling operation of the television receiver 41 in a mixed style. Moreover, a command for the player 40 is sometimes received from the wireless transceiver part 24. If the command is provided for the player 40 (step 131, YES), the command is executed (in step 132). If the command is not for the player 40 (step 131, NO) (e.g., the command is for the television receiver 41), the wireless transceiver part 17 is instructed to transmit the command (in step 133).

Upon receiving the command from the remote controller 43 and the wireless transceiver part 17, the wireless transceiver part 24 outputs the received command to the control part 53. The control part 53 executes the received command. Moreover, the control part 53 maintains the present power state of the television receiver 41. The power state of the television receiver 41 includes an ON state and an OFF state. During the ON state, the power supply circuit 23 supplies power to the display panel 21 and the Wireless HD transceiver part 51. During the OFF state, the power supply circuit 23 stops supplying power to the display panel 21 and the Wireless HD transceiver part 51. The power supply circuit 23 supplies the power when the power supply circuit 23 receives an instruction to start up from the control part 53, and stops supplying the power when the power supply circuit 23 receives an instruction to stop the same.

FIG. 9 is a flow chart showing a communication control process 900 executed by the control part 53 of the television receiver 41 in the wireless video reproduction system 700 of FIG. 7. The process 900 begins with the control part 53 determining the presence or absence of the notification of the command from the wireless transceiver part 24 (in step 140). When such command notification is made (step 140, YES), the power state is confirmed (in step 141). In a case where the power state is OFF (step 141, OFF), the control part 53 instructs the power supply circuit 23 to start up (in step 142). In a case where the power state is ON (step 141, ON) or after the power supply circuit 23 is started up (in step 142), the control part 53 judges whether the command is for the player 40 (in step 143). The keyboard 52 of the remote controller 42 is configured to include keys for controlling the operation of the player 40 and keys for controlling the operation of the television receiver 41 in a mixed style. If the command is not for the player 40 (step 143, NO) (e.g., the command is for the television receiver 41), the command is executed (in step 145). If the command is provided for the player 40 (step 143, YES), the wireless transceiver part 24 is instructed to transmit the command (in step 144).

FIG. 10 is a sequence chart 1000 when wireless communications are performed by using commands in the wireless video reproduction system 700 of FIG. 7. In the sequence chart 1000, it is first assumed that the wireless transceiver part 17 of the player 40 and the wireless transceiver part 24 of the television receiver 41 are in a receiving state 210 and a receiving state 217, respectively. When the player 40 performs wireless communications, the wireless transceiver part 17 of the player 40 makes a transition from the receiving state 210 to a transmitting state 211, and transmits a packet 215 including the desired command. In the transmitting state 211, the packet cannot be received. Therefore, after transmitting the packet, the wireless transceiver part 17 enters a receiving state 212, and awaits for reception of the acknowledgement signal. When the packet is received in the receiving state 217, the wireless transceiver part 24 makes a transition to a transmitting state 218 to transmit a packet 216, acknowledging the reception of the packet. After transmitting the packet 216, the wireless transceiver part 24 makes a transition to a receiving state 219. The wireless transceiver part 17 completes the transmission of the packet by receiving the acknowledgement signal.

FIG. 11 is a sequence chart 1100 when the wireless transceiver part 24 of the television receiver 41 does not receive the packet sent from the wireless transceiver part 17 in the wireless video reproduction system 700 of FIG. 7. In the chart 1100, the wireless transceiver part 17 transmits the packet 215 and transitions to the receiving state 212. If the packet 215 does not reach the wireless transceiver part 24, the wireless transceiver part 24 maintains its receiving state 217 and does not send an acknowledgement signal to the wireless transceiver part 17. When the wireless transceiver part 17 does not receive an acknowledgement signal within a specified time in the receiving state 212, the wireless transceiver part 17 performs packet transmission again. To this end, the wireless transceiver part 17 transitions to a transmitting state 220 to transmit a packet 221, and after transmitting the packet 221, the wireless transceiver part 17 transitions to a receiving state 222. When the wireless transceiver part 24 receives the packet 221, the wireless transceiver part 24 transitions to a transmitting state 223 to transmit the packet 224, acknowledging the reception of the packet 221. Thereafter, the wireless transceiver part 24 transitions to a receiving state 225. The wireless transceiver part 17 receives the packet 224, and the packet transmission is completed. By performing retransmission of the packet when the acknowledgement is not received, the wireless transceiver part 17 can improve reliability.

Although the sequence when the wireless transceiver part 17, i.e., the player 40 transmits a command has been described in FIGS. 10 and 11, a similar sequence is made also when the television receiver 41, i.e., the wireless transceiver part 24 transmits a command.

It is sometimes the case where the wireless transceiver part 17 and the wireless transceiver part 24 start transmission almost simultaneously. To illustrate one specific example, the wireless transceiver part 17 and the wireless transceiver part 24 may begin transmission almost simultaneously when the timer circuit 16 is started up almost simultaneously with operation of the player 40 by the user using the remote controller 43. In this case, deadlock may occur and both transceiver parts 17 and 24 may not receive the transmitted packet. The sequence in this case is shown in FIG. 12.

FIG. 12 is a sequence chart 1200 when the wireless transceiver part 17 of the player 40 and the wireless transceiver part 24 of the television receiver 41 start transmission substantially simultaneously in the wireless video reproduction system 700 of FIG. 7. In the sequence chart 1200, the wireless transceiver part 17 and the wireless transceiver part 24 are in a receiving state 240 and a receiving state 244, respectively. When instructions to transmit commands are issued almost simultaneously from the control part, the wireless transceiver part 17 transitions to a transmitting state 241-1 to transmit a packet 243-1 including the command, and thereafter transitions to a receiving state 242-1 to await for the acknowledgement signal. Meanwhile, the wireless transceiver part 24 also transitions to a transmitting state 245-1 to transmit a packet 247-1 including the command, and thereafter transitions to a reception state 246-1 to await for the acknowledgement signal. In this case, since the packet 243-1 reaches the wireless transceiver part 24 when the wireless transceiver part 24 is in the transmitting state 245-1, the wireless transceiver part 24 cannot receive the packet 243-1. Therefore, the wireless transceiver part 17, having not received the acknowledgement signal within a specified time from the wireless transceiver part 24, transitions again to the transmitting state 241-2 to transmit a packet 243-2 to the wireless transceiver part 24. Thereafter, the wireless transceiver part 17 transitions back to a receiving state 242-2. Similarly, since the packet 247-1 reaches the wireless transceiver part 17 when the wireless transceiver part 17 is in the transmitting state 241-2, the wireless transceiver part 17 cannot receive the packet 247-1. Therefore, the wireless transceiver part 24, having not received the acknowledgment signal within a specified time from the wireless transceiver part 17, transitions to a transmitting state 245-2 to transmit a packet 247-2 to the wireless transceiver part 17. Thereafter, the wireless transceiver part 24 transitions back to a receiving state 246-2.

As described above, deadlock may occur and the respective packets may not reach the intended destination.

### SUMMARY

An object of the instant application is to solve the aforementioned problems and provide a wireless communication system that includes a plurality of wireless communication terminal apparatuses and is able to perform mutual wireless communications even when two wireless communication terminal apparatuses simultaneously transmit commands to each other in the wireless communication system and wireless communication terminal apparatuses for the system.

In order to achieve the aforementioned objective, according to one aspect of the present application, there is provided a wireless communication system including at least a plurality of wireless communication terminal apparatuses, and each of the wireless communication terminal apparatuses includes first and second wireless communication apparatuses. The first wireless communication apparatus includes first and second wireless communication parts and a first control part. The first wireless communication part transceives digital data in a half-duplex communication mode via a first wireless communication path, the second wireless communication part transceives digital data in a full-duplex communication mode via a second wireless communication path, and the first control part controls transmission of digital data for the first and second wireless communication parts. The second wireless communication apparatus includes third and fourth wireless communication parts. The third wireless communication part transceives digital data in the half-duplex communication mode with the first wireless communication part via the first wireless communication path, and the fourth wireless communication part transceives digital data in the full-duplex communication mode with the second wireless communication part via the second wireless communication path. The first control part controls the first and second wireless communication parts to transmit identical digital data from both of the first and second wireless communication parts when instructing the second wireless communication apparatus to transmit digital data.

In the above-mentioned wireless communication system, the second wireless communication apparatus further includes a second control part configured to control receiving of digital data for the third and fourth wireless communication parts. When issuing an instruction to transmit identical digital data from both of the first and second wireless communication parts, the first control part issues an instruction to transmit the identical digital data with an identical frame number added to the identical digital data. When two pieces of the digital data with the identical frame number added are received by the third and fourth wireless communication parts, the second control part controls the digital data to abandon one piece of the digital data.

According to another aspect of the present application, there is provided a wireless communication apparatus serving as a first wireless communication apparatus, and the first wireless communication apparatus includes first and second wireless communication parts and a first control part. The first wireless communication part transceives digital data in a half-duplex communication mode via a first wireless communication path, the second wireless communication part transceives digital data in a full-duplex communication mode via a second wireless communication path, and the first control part controls transceiving of digital data for the first and second wireless communication parts. When instructing a second wireless communication apparatus that includes a third wireless communication part configured to transceive digital data in the half-duplex communication mode with the first wireless communication part via the first wireless communication path, and a fourth wireless communication part configured to transceive digital data in the full-duplex communication mode with the second wireless communication part via the second wireless communication path to transmit digital data, the first control part controls the digital data to transmit the digital data from both of the first and second wireless communication parts configured to the second wireless communication apparatus.

In the above-mentioned wireless communication apparatus, when issuing an instruction to transmit identical digital data from both of the first and second wireless communication parts, the first control part issues an instruction to transmit the identical digital data with an identical frame number added to the identical digital data.

According to a further aspect of the present application, there is provided a wireless communication apparatus serving as a second wireless communication apparatus to perform wireless communications with the first wireless communication apparatus that serves as the above-mentioned wireless communication apparatus. The second wireless communication apparatus includes third and fourth wireless communication parts and a second control part. The third wireless communication part transceives digital data in the half-duplex communication mode with the first wireless communication part via the first wireless communication path, the fourth wireless communication part transceives digital data in the full-duplex communication mode with the second wireless communication part via the second wireless communication path, and the second control part controls transceiving of digital data for the third and fourth wireless communication parts. When two pieces of the digital data with the identical frame number added are received by the third and fourth wireless communication parts, the second control part controls the digital data to abandon one piece of the digital data.

According to the wireless communication system and the wireless communication terminal apparatuses of the present application, the first control part controls the first and second wireless communication parts to transmit the identical digital data from both of the first and second wireless communication parts, when the second wireless communication apparatus is instructed to transmit the digital data. Therefore, mutual wireless communications can be performed even when both the wireless communication apparatuses try to simultaneously notify the other parties of the commands, and this allows highly reliable wireless communications to be achieved.

### BRIEF DESCRIPTION OF THE DRAWINGS

FIG. 1 is a block diagram showing a configuration of a wireless video reproduction system according to the instant application;

FIG. 2 is a flow chart showing an exemplary communication control process executed by a control part of a player in the wireless video reproduction system of FIG. 1;

FIG. 3 is a flow chart showing an exemplary communication control process executed by a control part of a television receiver in the wireless video reproduction system of FIG. 1;

FIG. 4 is a sequence chart when wireless communications are performed by using commands in a state in which both a player and a television receiver are in the power-off state in the wireless video reproduction system of FIG. 1;

FIG. 5 is a sequence chart when communications are performed by using commands in a state in which a television receiver on a receiving side is in the power-on state in the wireless video reproduction system of FIG. 1;

FIG. 6 is a sequence chart when communications are performed by transmitting commands substantially simultaneously in a state in which both a player and a television receiver are in the power-off state in the wireless video reproduction system of FIG. 1;

FIG. 7 is a block diagram showing a configuration of a wireless video reproduction system;

FIG. 8 is a flow chart showing a communication control process executed by a control part of a player in the wireless video reproduction system of FIG. 7;

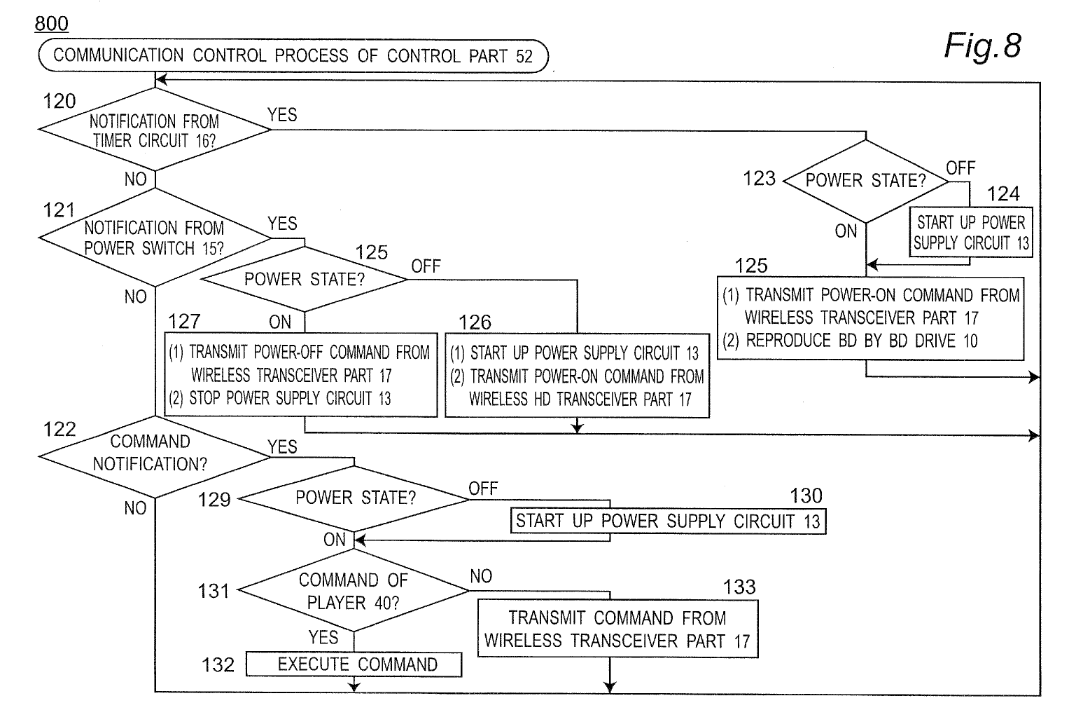

FIG. 9 is a flow chart showing a communication control process executed by the control part of a television receiver in the wireless video reproduction system of FIG. 7;

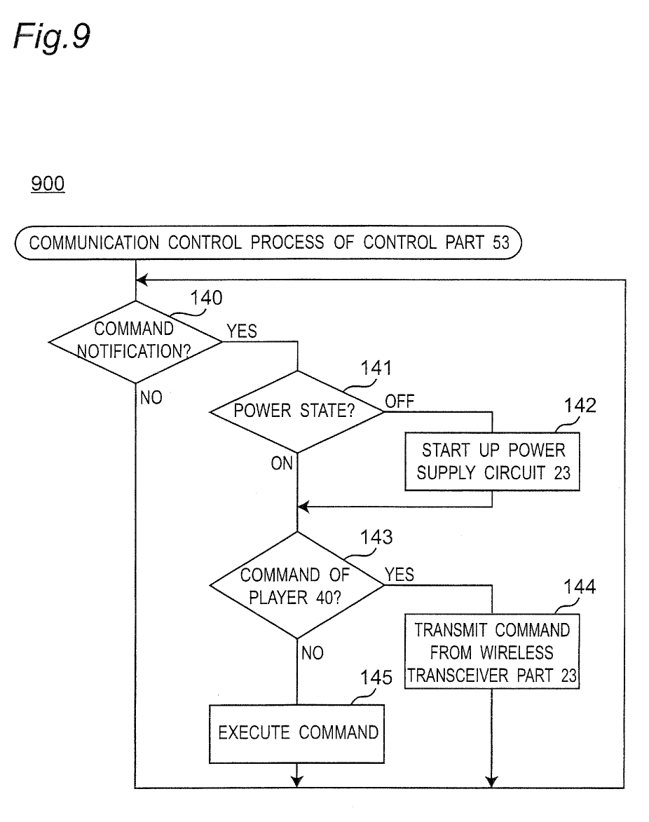

FIG. 10 is a sequence chart when wireless communications are performed by using commands in the wireless video reproduction system of FIG. 7.

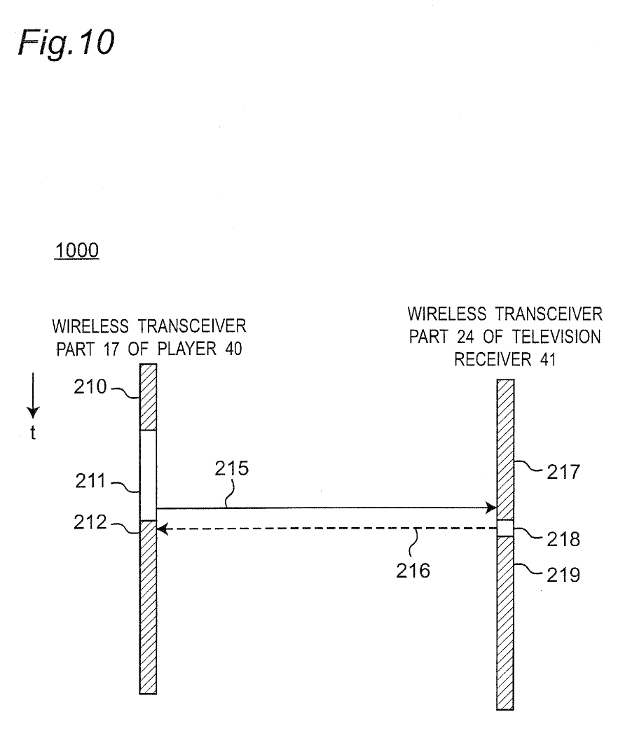

FIG. 11 is a sequence chart when a wireless transceiver part of a television receiver does not receive a packet sent from a wireless transceiver part in the wireless video reproduction system of FIG. 7; and

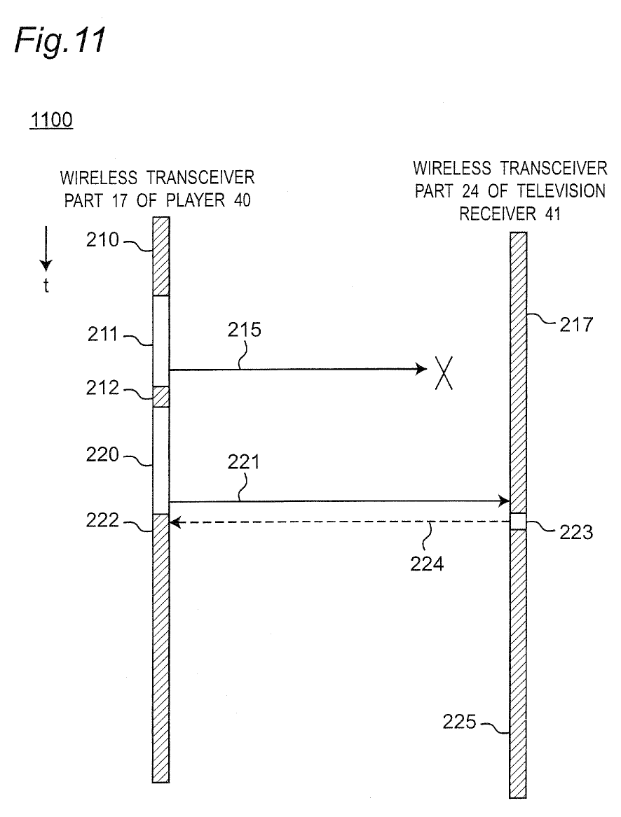

FIG. 12 is a sequence chart when a wireless transceiver part of a player and a wireless transceiver part of a television receiver start transmission substantially simultaneously in the wireless video reproduction system of FIG. 7.

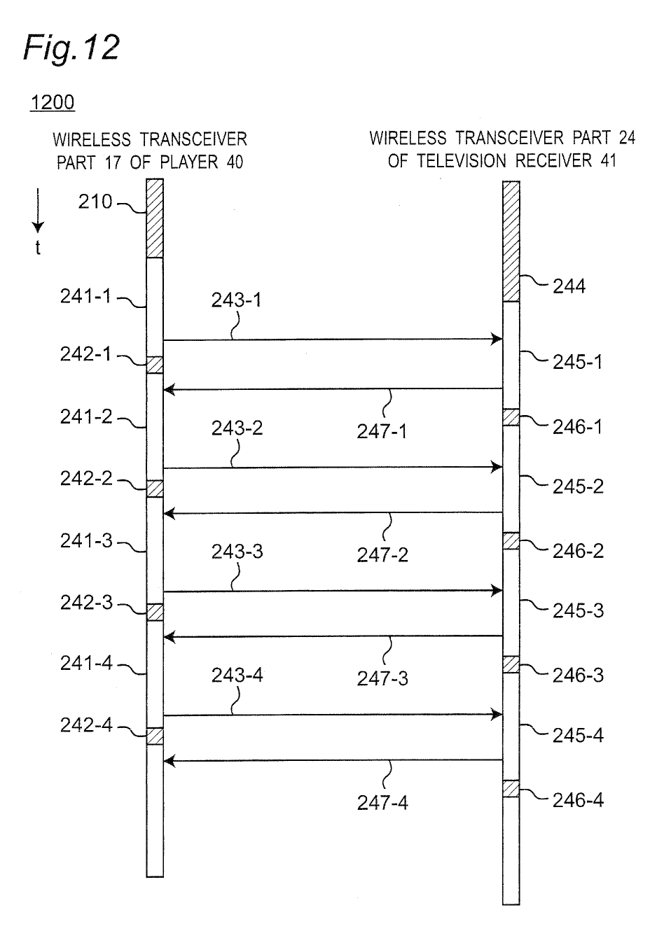

### DETAILED DESCRIPTION

Various implementations according to the instant application will be described below with reference to the attached drawings. In the specification, a term of “tranceive” means “transmit” and/or “receive”.

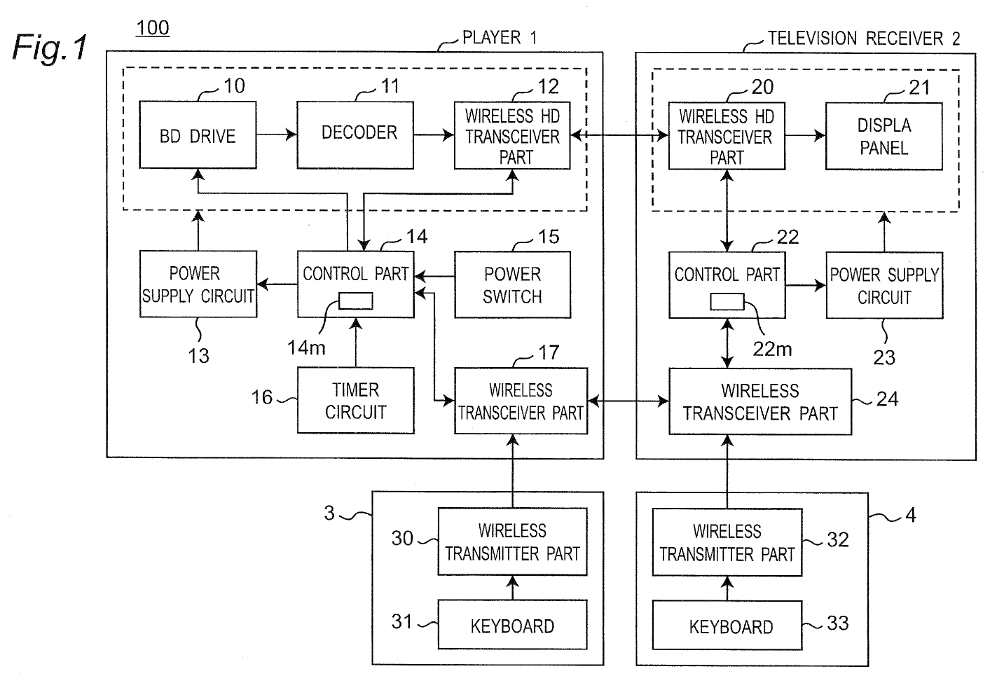

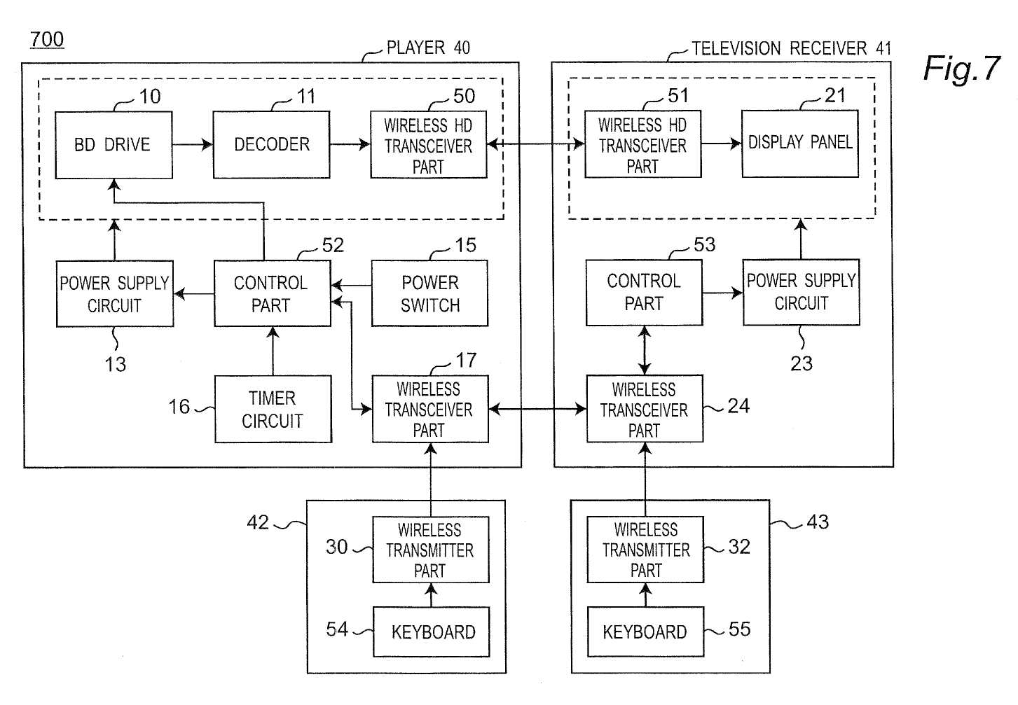

FIG. 1 is a block diagram showing a configuration of a wireless video reproduction system 100 according to the instant application. The wireless video reproduction system 100 includes the same components as the wireless video reproduction system 700 shown in FIG. 7. Therefore, for the sake of simplicity, the components of the wireless reproduction system 100 include the same reference numerals as the components of the wireless reproduction system 700.

The wireless video reproduction system 100 is configured to include a player 1 and a television receiver 2. A remote controller 3 is provided for the player 1, and a remote controller 4 is provided for the television receiver 2. When reproduction of a BD disc is performed in the player 1, reproduction of the BD disc is performed by a BD drive 10, and the reproduced stream is outputted to a decoder 11. The decoder 11 converts the inputted stream into a video signal and outputs the signal to a Wireless HD transceiver part 12. The Wireless HD transceiver part 12 encodes the inputted video signal into a wireless signal that includes the video signal and transmits the signal to a Wireless HD transceiver part 20 of the television receiver 2. It is noted that the Wireless HD transceiver parts 12 and 20 perform wireless communications in the full-duplex mode in a system compliant to the Wireless HD Standard.

The Wireless HD transceiver part 20 of the television receiver 2 decodes the video signal from the received wireless signal and outputs the resulting signal to a display panel 21. The display panel 21 displays the images of the video signal. The BD drive 10, the decoder 11 and the Wireless HD transceiver part 12 are supplied with the power by a power supply circuit 13, and the power supply is arbitrarily turned ON or OFF by a control part 14.

Moreover, the Wireless HD transceiver part 20 and the display panel 21 are supplied with the power by a power supply circuit 23, and the power supply is arbitrarily turned ON or OFF by a control part 22. Parts other than the parts supplied with the power by the power supply circuit 13 and the power supply circuit 23 are consistently supplied with the power by a power supply not shown in the figure. The remote controller 3 is configured to include a keyboard 31 and a wireless transmitter part 30. The keyboard includes a plurality of keys for operating the player 1 and the television receiver 2, and a command is assigned to each of the keys. When a certain key of the keyboard 31 is selected, a command corresponding to the selected key is transmitted to the wireless transmitter part 30, and the wireless transmitter part 30 transmits the received command to a wireless transceiver part 17. These commands include, for example, a turning—ON/OFF command for turning ON/OFF the power of the player 1, a turning—ON/OFF command for turning ON/OFF the power of the television receiver 2, a reproduction, stop and fast-forwarding command for reproduction, stop, and fast-forwarding of the BD drive 10, and so on. The remote controller 4 is configured to include a keyboard 33 and a wireless transmitter part 32. The keyboard 33 includes a plurality of keys for operating the player 1 and the television receiver 2, and a command is assigned to each of the keys. When a certain key of the keyboard 33 is selected, a command corresponding to the selected key is transmitted to the wireless transmitter part 32, and the wireless transmitter part 32 transmits the command to a wireless transceiver part 24. These commands include, for example, a turning—ON/OFF command for turning ON/OFF the power of the player 1, a turning—ON/OFF command for turning ON/OFF the power of the television receiver 2, a reproduction, stop and fast-forwarding command for reproduction, stop, and fast-forwarding of the BD drive 10, a change in the brightness command for changing the brightness of the screen, and so on.

The Wireless HD transceiver part 12 transmits a wireless signal that includes the video signal to the Wireless HD transceiver part 20. The Wireless HD transceiver 12 transmits and/or receives a wireless signal that includes commands to/from the Wireless HD transceiver part 20. A command transmitting instruction in the Wireless HD transceiver part 12 is performed by the control part 14. Moreover, when a command is received by the Wireless HD transceiver part 12, the control part 14 is notified of the reception of the command. It is noted that the wireless transmitter parts 30 and 32, similar to the wireless transceiver part 17 and the wireless transceiver part 24, perform wireless communications in the half duplex communication mode in a system compliant to the IEEE802.15.4 standard.

The Wireless transceiver part 17 receives the command transmitted from the remote controller 3 and the wireless transceiver part 24, and outputs the command to the control part 14. Moreover, when being instructed to transmit a command from the control part 14, the wireless transceiver part 17 transmits a wireless signal that includes the command to the wireless transceiver part 24. When receiving the wireless signal that includes a command, the wireless transceiver part 17 transmits an acknowledgement signal to the originating part. Similarly, when transmitting the wireless signal that includes a command, the wireless transceiver part 17 waits for an acknowledgment signal from the destination part. In a case where the acknowledgement signal is not received within a specified time from the time the command is transmitted, the wireless transceiver part 17 retransmits the command, i.e., so-called retry is executed. This may continue until the acknowledge signal is received. It is noted that a wireless communication path (or wireless communication line) between the wireless transceiver parts 17 and 24 and a wireless communication path (or wireless communication line) between the Wireless HD transceiver parts 12 and 20 are wireless communication paths that include, for example, mutually different frequency bands or channels.

The power switch 15 is a switch operable by the user, and when the power switch 15 is selected, information about such selection is outputted to the control part 14. A timer circuit T16 internally is configured to include a clock circuit. The clock circuit may be used to determine whether a specified time has been reached. If so, the timer circuit T16 notifies the control part 14 of the same. The power supply circuit 13 supplies power to the BD drive 10, the decoder 11 and the Wireless HD transceiver part 12. The power supply circuit 13 supplies power when being instructed to start up from the control part 14 or stops supplying the power when being instructed to stop the same.

The control part 14 may receive a notification that it has become the specified time from the timer circuit 16, a notification that the switch has been selected from the power switch 15, a notification about a command from the wireless transceiver part 17, and a notification about a command from the Wireless HD transceiver part 12. The command may be received from the wireless transceiver part 17 and the Wireless HD transceiver part 12 and may be treated in the same manner at the control part 14 regardless of its origin. These commands may include a sequence number. The sequence number may be a number incremented for each command. The control part 14 stores the sequence number in a memory 14m inside the control part 14, adds the sequence number to the command to be transmitted, and transmits the command along with the added sequence number. Moreover, the control part 14 stores the sequence number included in the command notified last as a reception sequence number in the memory 14m inside the control part 14.

The control part 14 may maintain the present power state of the player 1. The power state has an on-state and an off-state. The on-state is provided when the power supply circuit 13 is started up. The off-state is provided when the power supply circuit 13 is stopped.

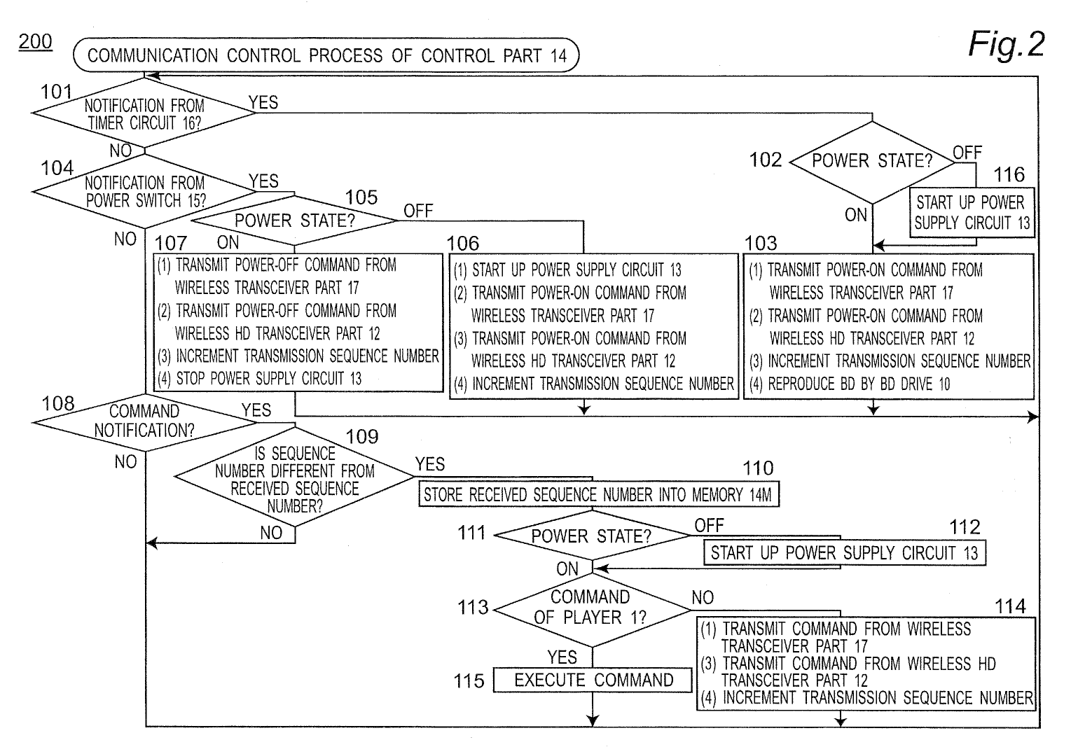

FIG. 2 is a flow chart showing an exemplary communication control process 200 executed by the control part 14 of the player 1 in the wireless video reproduction system 100 of FIG. 1. The process 200 begins with the control part 14 determining whether a notification from the timer circuit 16 has been received (in step 101). When there is such notification (step 101, YES), the control part 14 determines the power state (in step 101). When the power state is OFF (step 102, OFF), the control part 14 instructs the power supply circuit 13 to start up (in step 116). In a case where the power state is ON (step 102, ON) or after the power supply circuit 13 is started up, the control part 14 instructs the wireless transceiver part 17 to transmit a power-on command, instructs the Wireless HD transceiver part 12 to transmit a power-on command, increments the transmission sequence number in the memory 14m, and instructs the BD drive 10 to reproduce the BD (in step 103). Upon receiving a command from the control part 14, the wireless transceiver part 17 transmits the command instructed to be transmitted to the wireless transceiver part 24 of the television receiver 41. Similarly, upon receiving a command from the control part 14, the Wireless HD transceiver part 12 transmits the command instructed to be transmitted to the wireless transceiver part 20 of the television receiver 2. The command transmitted by the wireless transceiver part 17 and the command transmitted by the Wireless HD transceiver part 12 may have an identical sequence number.

When there is no notification from the timer circuit 16 (step 101, NO), the control part 14 determines whether there is a notification from the power switch 15 (in step 104). When there is such a notification from the power switch 15 (step 104, YES), the control part 14 determines the power state (in step 105). When the power state is ON (step 105, ON), the control part 14 instructs the wireless transceiver part 17 to transmit a power-off command, instructs the Wireless HD transceiver part 12 to transmit a power-off command, increments the transmission sequence number in the memory 14m, and stops the power supply circuit 13 (in step 107). When the power state is OFF (step 105, OFF), the control part 14 instructs the power supply circuit 13 to start up, instructs the wireless transceiver part 17 to transmit a power-on command, instructs the Wireless HD transceiver part 12 to transmit a power-on command, and increments the transmission sequence number in the memory 14m (in step 106).

When there is no notification from the power supply switch 16 (step 104, NO), the presence or absence of the command notification from the wireless transceiver part 17 and the Wireless HD transceiver part 12 is judged (in step 108). When there is such a command notification (step 108, YES), the control par 14 determines the sequence number included in the command (in step 109). When the sequence number is identical to the reception sequence number stored in the memory 14m (step 109, NO), no execution is performed. That is, the command (received digital data) is abandoned. When the sequence number is different from the reception sequence number stored in the memory 14m (step 109, YES), the control part 14 stores the reception sequence number into the memory 14m (in step 110), and determines the power state (in step 111). When the power state is OFF (step 111, OFF), the control part 14 instructs the power supply circuit 13 to start up (in step 112). In a case where the power state is ON (step 111, ON) or after the power supply circuit 13 is started up, the control part 14 determines whether the command is a command for the player 1 or a command for the television receiver 2 (in step 113). The keyboard 31 of the remote controller 3 is configured to include keys to operate the player 1 and keys to operate the television receiver 2 in a mixed style. When the command is provided for the player 1, the command is executed (in step 115). When the command is provided for the television receiver 2, the wireless transceiver part 17 is instructed to transmit the corresponding command, the Wireless HD transceiver part 12 is instructed to transmit the command, and the transmission sequence number in the memory 14m is incremented.

The operation of the television receiver 2 is described next with reference to FIG. 1. Upon receiving the command from the remote controller 4 and the wireless transceiver part 17, the wireless transceiver part 24 outputs the received command to the control part 22. The control part 22 executes the command. Moreover, the control part 22 maintains the present power state of the television receiver 2. The power state has on- and off-states. The on-state is provided when the power supply circuit 23 is started up. The off-state is provided when the power supply circuit 23 is stopped. The power supply circuit 23 supplies the power to the Wireless HD transceiver part 20 and the display panel 21. The power supply circuit 23 supplies the power when being instructed to start up from the control part 22 or stops supplying the power when being instructed to stop the same.

The Wireless HD transceiver part 20 receives a wireless signal that includes the video signal from the Wireless HD transceiver part 12. The Wireless HD transceiver part 20 transmits and/or receives a wireless signal that includes a command to/from the Wireless HD transceiver part 12. The command transmission instruction may be performed by the control part 22. When the Wireless HD transceiver part 20 receives a command, the control part 22 may be notified of the reception of the command. In addition to receiving a command notification from the Wireless HD transceiver part 20, the control part 22 may receive a command notification from the wireless transceiver part 24.

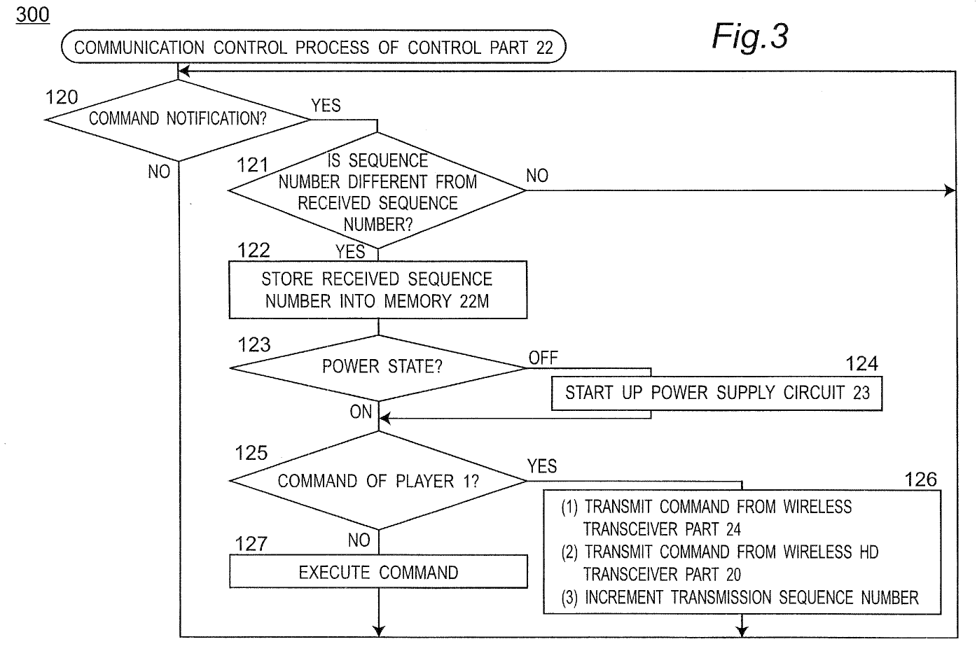

FIG. 3 is a flow chart showing an exemplary communication control process 300 executed by the control part 22 of the television receiver 2 in the wireless video reproduction system 100 of FIG. 1. The process 300 begins with the control part 22 judging for the presence or absence of a command notification from the wireless transceiver part 24 or the Wireless HD transceiver part 20 (in step 120). When the command notification is made, the control part 22 determines whether the sequence number included in the command is different from the reception sequence number stored in the memory 22m (in step 121). When the sequence number is identical to the reception sequence number stored in the memory 22m (step 121, NO), no execution is performed. That is, the received command (received digital data) is abandoned. When the sequence number is different from the reception sequence number stored in the memory 22m (step 121, YES), the control part 22 stores the sequence number included in the command into the memory 22m as the received sequence number (in step 122), and determines the power state (in step 123). In a case where the power state is OFF (step 123, OFF), the control part 22 instructs the power supply circuit 23 to start up (in step 124). In a case where the power state is ON (step 123, ON) or after the power supply circuit 23 is started up, the control part 22 judges whether the received command is a command for the player 1 or a command for the television receiver 2 (in step 125). The keyboard 31 of the remote controller 4 is configured to include keys to operate the player 1 and keys to operate the television receiver 2 in a mixed style. When the command is provided for the television receiver 2, the corresponding command process is executed (in step 127). When the command is provided for the player 1, the control part 22 instructs the wireless transceiver part 24 to transmit the command, instructs the Wireless HD transceiver part 20 to transmit the command, and increments the transmission sequence number in the memory 22m (in step 126).

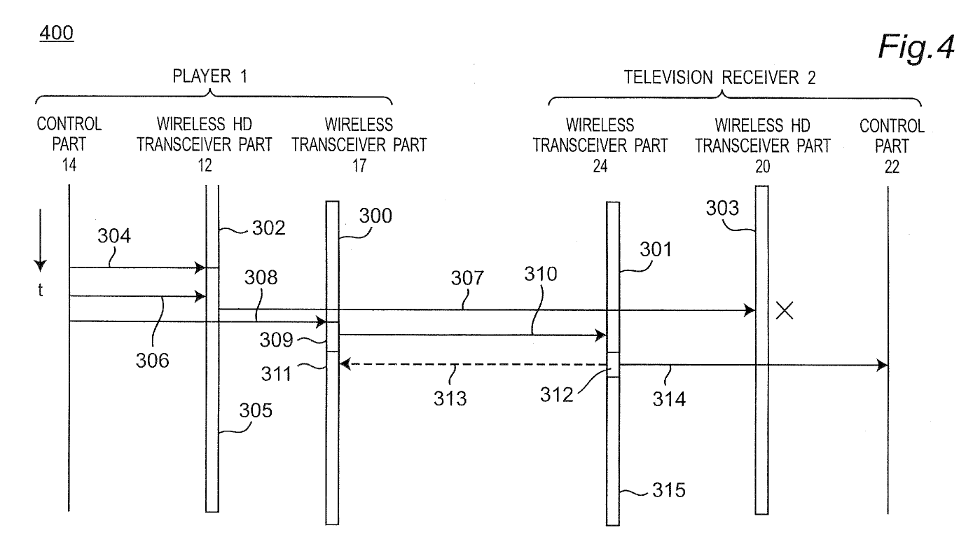

FIG. 4 is a sequence chart 400 when wireless communications are performed by using commands in a state in which both the player 1 and the television receiver 2 are in the power-off state in the wireless video reproduction system 100 of FIG. 1. When both the player 1 and the television receiver 2 are in the power-off state at the beginning of the sequence chart 400, the wireless transceiver part 17 and the wireless transceiver part 24 are in a receiving state 300 and a receiving state 301, respectively. Moreover, the power states of the control part 14 and the control part 22 are in an off-state 302 and an off-state 303, respectively, and no power is supplied to the Wireless HD transceiver part 12 and the Wireless HD transceiver part 20.

Referring to FIG. 4, when the player 1 performs wireless communications, the control part 14 starts up the power supply circuit 13 to supply the power to the Wireless HD transceiver part 12 (304). The power supply circuit 13 supplies the power, so that the power state enters an on-state 305, and the Wireless HD transceiver part 12 is supplied with the power. Subsequently, the control part 14 instructs the Wireless HD transceiver part 12 to transmit a command to the Wireless HD transceiver part 20 (306). In response, the Wireless HD transceiver part 12 transmits the command (307). However, the command is not received by the Wireless HD transceiver part 20 since the Wireless HD transceiver part 20 is not supplied with the power. In addition to instructing the Wireless HD transceiver part 12 to transmit the command, the control part 14 instructs the wireless transceiver part 17 to transmit the same or substantially same command to the wireless transceiver part 24 (308). In response, the wireless transceiver part 17 transitions to a transmitting state 309 to transmit a packet 310, and thereafter transitions to a receiving state 311 to receive an acknowledgement signal. Upon receiving the packet 310, the wireless transceiver part 24 transitions to a transmitting state 312 to transmit the acknowledgement signal 313 and notify the control part 22 of the reception of the packet (314). Then, the wireless transceiver part 24 transitions to a receiving state 315. The wireless transceiver part 17 completes the transmission of the packet by receiving the acknowledgement signal 313.

As described above, by performing packet communications between the wireless transceiver part 17 and the wireless transceiver part 24 even if the power state of the Wireless HD transceiver part 20 is off, the receiving side can be notified of the desired command.

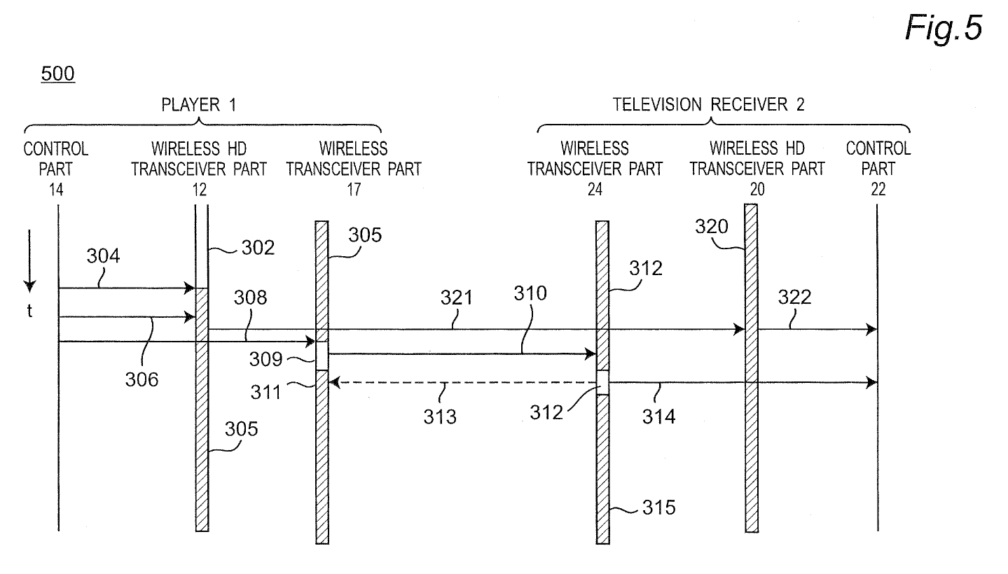

FIG. 5 is a sequence chart 500 when communications are performed by using commands in a state in which the television receiver 2 on the receiving side is in the power-on state in the wireless video reproduction system 100 of FIG. 1. The sequence chart 500 is schematically similar to the sequence chart 400 of FIG. 4. Points of differences are described below.

In the sequence chart 500, the power state of the Wireless HD transceiver part 20 is an on-state 320. The Wireless HD transceiver part 12 receives a transmission instruction 306, and transmits a command 321 to the Wireless HD transceiver part 20. In this case, since the power state of the Wireless HD transceiver part 20 is ON, command transmission to the Wireless HD transceiver part 20 is successful. Upon receiving the command 321, the Wireless HD transceiver part 20 makes a packet notification to the control part 22 (322). In this manner, the control part 22 is notified of the command from both the Wireless HD transceiver part 20 and the wireless transceiver part 24. In this case, the control part 22 examines the sequence number included in each packet. Upon determining the sequence numbers are identical, the control part 22 executes a process for the command notification received first and executes no process for the command notification received second for the identical sequence number. That is, the command (received digital data) of the notification received second is abandoned. The control part 22 stores the sequence number as a received sequence number into the memory 22m when the command notification is received and the process for the command is executed. The control part 22 checks when the notification of the command of the identical sequence number is made later, and does not execute a process associated with the later received commend in the case of the identical sequence number. That is, the command (received digital data) is abandoned.

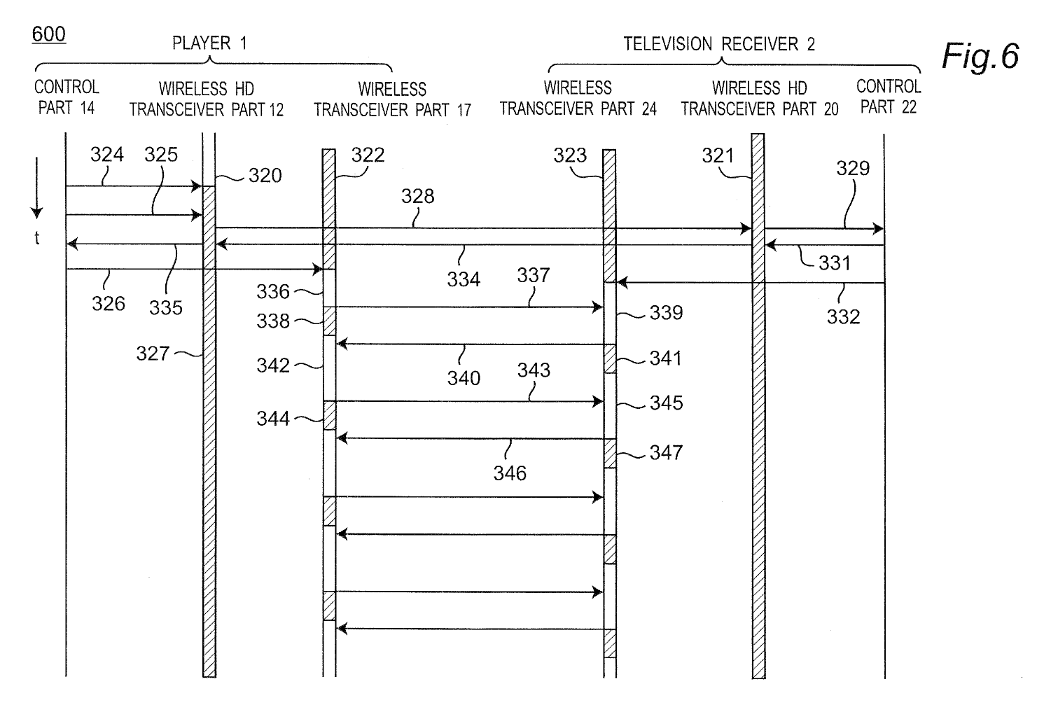

FIG. 6 is a sequence chart 600 when communications are performed by transmitting commands substantially simultaneously in a state in which both the player 1 and the television receiver 2 are in the power-off state in the wireless video reproduction system 100 of FIG. 1. During initial phases of the sequence chart 600, the Wireless HD transceiver part 12 and the Wireless HD transceiver part 20 are assumed to have the power states of an off-state 320 and an on-state 321, respectively. Moreover, the wireless transceiver part 17 and the wireless transceiver part 24 are assumed to be in a receiving state 322 and a receiving state 323, respectively.

In the sequence chart 600, the control part 14 brings the power state into an on-state when transmitting a command (324), instructs the Wireless HD transceiver part 12 to transmit the command (325), and instructs the wireless transceiver part 17 to transmit the command (326). The Wireless HD transceiver part 12 enters an on-state 327, and then transmits a command 328 to the Wireless HD transceiver part 20. Upon receiving the command 328, the Wireless HD transceiver part 20 notifies the control part 22 of the command (329).

The control part 22 also performs command transmission substantially at the same time as the control part 14. To this end, the control part 22 instructs the Wireless HD transceiver part 20 to transmit the command (331), and instructs the wireless transceiver part 24 to transmit the same command (332). The Wireless HD transceiver part 20 transmits a command (334) to the Wireless HD transceiver part 12. Upon receiving the command (334), the Wireless HD transceiver part 12 notifies the control part 14 of the command (335).

Meanwhile, the wireless transceiver part 17, which is notified of the command transmission, transitions to a transmitting state 336 to transmit a packet 337 to the wireless transceiver part 24, and thereafter transitions to a receiving state 338. Meanwhile, the wireless transceiver part 24 also transitions to a transmitting state 339 substantially at the same time to transmit a packet 340, and thereafter transitions to a receiving state 341. Since the packet 337 reaches the wireless transceiver part 24 when the wireless transceiver part 24 is in a transmitting state 339, the packet cannot be accepted. As a result, the wireless transceiver part 17 does not receive an acknowledgement signal. Therefore, the wireless transceiver part 17 transitions from a receiving state 338 to a transmitting state 342 to retransmit a packet 343, and thereafter transitions to a receiving state 344.

Meanwhile, since the packet 340 reaches the wireless transceiver part 17 when the wireless transceiver part 17 is in a transmitting state 342, the packet cannot be accepted. As a result, the wireless transceiver part 24 does not receive an acknowledge signal when in the receiving state 341. Therefore, the wireless transceiver part 24 transitions to a transmitting state 345 to retransmit a packet 346, and thereafter transitions to a receiving state 347. As described above, the wireless transceiver part 17 and the wireless transceiver part 24 repeat retry for a specified number of times. However, commands transceiving can be performed between the Wireless HD transceiver part 12 and the Wireless HD transceiver part 20. Therefore, it is possible to exchange commands between the player 1 and the television receiver 2 without depending on the power state and even if the transmitting timings are almost simultaneous.

Other implementations are contemplated. For example, although the sequence when the player 1 transmits a command has been described in FIGS. 4 and 5, a similar sequence is provided also when the television receiver 2 transmits a command. For another example, the present application is not limited to the wireless video reproduction system having the player 1 and the television receiver 2. The player 1 and the television receiver 2 may be electronic equipment having various wireless communication terminal apparatuses or wireless communication terminal apparatuses having electronic equipment, and a wireless communication system may be configured to transceive digital data between at least a plurality of wireless communication apparatuses. Moreover, the television receiver 2 may be a display panel apparatus that has, for example, a display function.

According to the wireless communication system and the wireless communication terminal apparatuses of the instant application, the first control part may control the first and second wireless communication parts to transmit the identical digital data from both of the first and second wireless communication parts, when the second wireless communication apparatus is instructed to transmit the digital data. Therefore, mutual wireless communications can be performed even when both the wireless communication apparatuses try to simultaneously notify the other parties of the commands, and this allows highly reliable wireless communications to be achieved.

The instant application can be utilized for equipment that performs wireless communications between apparatuses such as a television receiver and a player, and is particularly suitable for equipment in which wireless communication commands are simultaneously generated.

Other implementations are contemplated.

What is claimed is:

1. A wireless communication system comprising first and second wireless communication apparatuses, wherein:
the first wireless communication apparatus includes:
a first wireless communication part configured to transceive via a first wireless communication path digital data in a half-duplex communication mode;
a second wireless communication part configured to transceive via a second wireless communication path digital data in a full-duplex communication mode; and
a first control part configured to control transceiving of digital data for the first and second wireless communication parts,
the second wireless communication apparatus includes:
a third wireless communication part configured to transceive via the first wireless communication path digital data in the half-duplex communication mode; and
a fourth wireless communication part configured to transceive via the second wireless communication path digital data in the full-duplex communication mode,
the first control part is configured to control the first wireless communication part to transmit a first command to the third wireless communication part, and
the first control part is configured to control the second wireless communication part to transmit a second command to the fourth wireless communication part, the second commend being the same as the first command.

2. The wireless communication system of claim 1, wherein the first control part is configured to control the first wireless communication part to transmit the first command and the second wireless communication part to transmit the second command when instructing the second wireless communication apparatus to transmit digital data.

3. The wireless communication system of claim 1, wherein:
the second wireless communication apparatus further includes a second control part configured to receive a notification associated with each of the first and second commands,
the first control part is configured to control the first wireless communication part to transmit a first frame number along with the first command and to control the second wireless communication part to transmit a second frame number along with the second command, the first frame number being the same as the second frame number, and
the second control part is configured to abandon the first command or the second command upon determining that the first sequence number is the same as the second sequence number.

4. The wireless communication system of claim 1, wherein:
the first wireless communication apparatus includes a player for reproduction of a disc, and
the second wireless communication apparatus includes a television receiver.

5. The wireless communication system of claim 1, wherein:
the first wireless communication apparatus includes a television receiver, and
the second wireless communication apparatus includes a player for reproduction of a disc.

6. A first wireless communication apparatus comprising:
a first wireless communication part configured to transceive via a first wireless communication path digital data in a half-duplex communication mode;
a second wireless communication part configured to transceive via a second wireless communication path digital data in a full-duplex communication mode; and
a control part configured to control the first wireless communication part to transmit a first command to a second wireless communication apparatus, and to control the second wireless communication part to transmit a second command to the second wireless communication apparatus, the second commend being the same as the first command.

7. The first wireless communication apparatus of claim 6, wherein the control part is configured to control the first wireless communication part to transmit the first command and the second wireless communication part to transmit the second command when instructing the second wireless communication apparatus to transmit digital data.

8. The first wireless communication apparatus of claim 6, wherein the control part is configured to control the first wireless communication part to transmit a first frame number along with the first command and to control the second wireless communication part to transmit a second frame number along with the second command, the first frame number being the same as the second frame number.

9. The wireless communication system of claim 6, wherein the first wireless communication apparatus includes a player for reproduction of a disc.

10. The wireless communication system of claim 6, wherein the first wireless communication apparatus includes a television receiver.

11. A second wireless communication apparatus comprising:
a first wireless communication part configured to receive, via a first wireless communication path and from a first wireless communication apparatus, a first command in a half-duplex communication mode;
a second wireless communication part configured to receive, via a second wireless communication path and from a second wireless communication apparatus, a second command in a full-duplex communication mode; and
a control part configured to identify a first frame number associated with the first command and a second frame number associated with the second command and abandon the first command or the second command upon determining that the first frame number and the second frame number are the same.

12. The second wireless communication apparatus of claim 11, wherein:
the first wireless communication apparatus includes a player for reproduction of a disc, and
the second wireless communication apparatus includes a television receiver.

13. The second wireless communication apparatus of claim 11, wherein:
the first wireless communication apparatus includes a television receiver, and
the second wireless communication apparatus includes a player for reproduction of a disc.
